(19) United States
(12) Patent Application Publication
(10) Pub. No.: US 2016/0299339 A1
(43) Pub. Date: Oct. 13, 2016

(54) METHOD FOR EXTENDED DEPTH OF FIELD IMAGING

(71) Applicant: B.G. NEGEV TECHNOLOGIES AND APPLICATIONS LTD., AT BEN-GURION UNIVERSITY, Beer Sheva (IL)

(72) Inventors: Iftach KLAPP, Modi'in - Macabim - Re'ut (IL); Asi SOLODAR, Ashkelon (IL); Ibrahim ABDULHALIM, Neve Shalom (IL)

(21) Appl. No.: 15/100,394

(22) PCT Filed: Dec. 3, 2014
(86) PCT No.: PCT/IL2014/051050

§ 371 Date: May 31, 2016

Related U.S. Application Data
(60) Provisional application No. 61/912,036, filed on Dec. 5, 2013.

(51) Int. Cl. G02B 27/00; H04N 5/247; G02F 1/139; H04N 5/232; G02B 27/58; G02B 3/00

(52) U.S. Cl. CPC G02B 27/0075; G02B 27/58; G02B 3/0081; G02B 27/0068; G02F 1/139; H04N 5/23235; H04N 5/247

(57) ABSTRACT

The invention is a method for providing Tunable Extended Depth of Field (TEDOF) to an optical system. The method comprises: (a) providing at least one tunable Spatial Light Modulator (SLM) in the pupil plane or in the conjugate plane of the pupil plane of the optical system; (b) building a database of masks tailored to the structure of the tunable SLMs; (c) using the optical system to grab at least two images using different masks from the database of masks; and (d) time multiplexing the wavefront profiles of the at least two images to produce a final image. Each of the profiles in the database gives a Depth of Field (DOF) lower than the DOF of the final image.

### FIELD OF THE INVENTION

The invention is from the field of optical imaging. In particular the invention is from the field of extending the depth of field (DOF) of optical systems using a spatial light modulator (SLM).

### BACKGROUND OF THE INVENTION

Publications and other reference materials referred to herein are numerically referenced in the following text and respectively grouped in the appended Bibliography which immediately precedes the claims.

The resolution and illumination of a well-designed optical system are both important for achieving high quality images. They are limited by the system's numerical aperture (NA). Increasing the NA improves the system resolution and illumination. However, an increased NA results in a lower depth of field (DOF). In recent years many authors suggested methods to bypass this problem by adding a proper phase mask, amplitude mask or passive birefringent plate, to provide extended depth of field (EDOF), while keeping a required resolution unchanged [1]-[8]. EDOF implementation may be “all-optical” [1]-[4] or supported by image processing [5]-[8]. Masks for EDOF were also implemented in microscopy, however there the appearance of the object may be perplexing. A flexible EDOF may allow the observer to adjust the amount of the visual information to accommodate it to his perception. In the large aspect of photography, tunable EDOF allows including or excluding objects in various depths of the scenery. In previous work [9] the authors built a tunable EDOF microscope and investigated the tradeoff between the resolution and the EDOF for the use of micro object manipulation systems which are based on visual feedback. A cubic phase mask [6],[7] was implemented using SLM. The range of EDOF was changed by changing the coefficient of the cubic phase mask. This, however, requires high resolution SLM and image restoration which is expensive and may be inconvenient for real time use due to the required image restoration.

A temporal multiplexing is in use in the display projectors for controlling the color and gain [9] and in wavefront coding. Rasker suggested using a temporally modulated shutter, the shutter was deliberately modulated in pseudo-random order to improve system de-blurring performances [11].

It is the purpose of the present invention to provide a low cost device and method for obtaining wide range EDOF, which is tunable using electronic signal.

Further purposes and advantages of the present invention will appear as the description proceeds.

### SUMMARY OF THE INVENTION

The invention is a method for providing Tunable Extended Depth Of Field (TEDOF) to an optical system. The method comprises:
a. providing at least one tunable Spatial Light Modulator (SLM) in the pupil plane or in the conjugate plane of the pupil plane of the optical system;
b. building a database of masks tailored to the structure of the tunable SLMs;
c. using the optical system to grab at least two images using different masks from the database of masks; and
d. time multiplexing the wavefront profiles of the at least two images to produce a final image.

Each of the profiles gives a Depth of Field (DOF) lower than the DOF of the final image.

In embodiments of the method of the invention the multiplexing is done off line on a generated database of images corresponding to the different wavefront profiles generated at the pupil plane of the imaging system or its conjugate either in transmission or in reflection modes. In other embodiments of the method of the invention the multiplexing is done on line in real time.

In embodiments of the method of the invention each wavefront profile provides EDOF of the imaging system.

In embodiments of the method of the invention the SLMs spatially modulate at least one of the phase, the amplitude, or the polarization or any combination of these parameters of the wavefront.

In embodiments of the method of the invention the SLMs comprise liquid crystals, an electro-optic or magneto-optic material or a mechanical deformable micro mirror array.

In embodiments of the method of the invention the method is used for image restoration.

In embodiments of the method of the invention the SLMs have circular symmetry. In these embodiments the SLMs can be comprised of annular sections, each of which is controlled separately. In some of these embodiments the SLMs are comprised of no more than ten annular sections.

In embodiments of the method of the invention the central part of the mask is obstructed. In embodiments of the method of the invention wherein the SLMs are comprised of annular sections several annular sections of the mask can be obstructed.

In embodiments of the method of the invention at least one of the SLMs can be a single pixel tunable focus lens.

The method of the invention can be used with multi-camera systems in which each camera channel has its own tunable EDOF.

Embodiments of the method of the invention can be used with a multispectral or a hyperspectral imaging system the method can comprise generating the SLM masks for each particular wavelength separately.

In embodiments of the method of the invention the SLMs can be used for chromatic corrections thereby allowing simultaneous correction of both focus and EDOF.

Embodiments of the method of the invention can be used with a camera having RGB channels, in these embodiments the method can comprise synchronizing the camera RGB channels with the SLMs, thereby allowing correction for wavelength dependence by grabbing sequentially the color channels associated with the optimized SLM's mask for each specific color and then, after processing, displaying the final RGB image with improved EDOF.

In embodiments of the method of the invention the SLM masks can be integrated into a digital camera system. The digital camera system can be that of a mobile phone and the processing abilities of the phone can be used to operate the SLMs and the processing of the grabbed images.

In embodiments of the method of the invention, after the final image has been produced, it is image processed for contrast and resolution enhancement.

All the above and other characteristics and advantages of the invention will be further understood through the following illustrative and non-limitative description of embodiments thereof, with reference to the appended drawings.

### BRIEF DESCRIPTION OF THE DRAWINGS

FIG. 1A shows a typical uniaxial birefringent nematic LC material having planar geometry characterized by two refractive indices;

FIG. 1B shows a simplified cross-section of a LC cell;

FIG. 1C shows the first embodiment of the invention in which annular SLM is used;

FIG. 2A shows an embodiment of the invention in a light microscope system;

FIG. 2B shows embodiment of the invention in a general imaging system;

FIG. 3 is a schematic presentation of a simulated system used in a simulation carried out to demonstrate the invention;

FIG. 4 shows the results of a simulation carried out using the system of FIG. 3;

FIG. 5 schematically shows an experimental arrangement used to demonstrate the invention;

FIG. 6 shows the “database” used in carrying out the experiment;

FIG. 7A shows the average target contrast vs. defocus in mm measured in the experiment;

FIG. 7B shows the three areas on USAF1951 target at which the contrast was measured;

FIG. 8 presents the tunable EDOF experimental results found after temporal multiplexing on the “database” components of FIG. 6; and

FIGS. 9A and 9B show respectively the result of inverting the EDOF order using the same weight vector in simulated and actual experiments.

### DETAILED DESCRIPTION OF EMBODIMENTS OF THE INVENTION

The invention is a tunable EDOF (Extended Depth of Field) method and apparatus. The apparatus comprises a tunable Spatial Light Modulator (SLM) and some embodiments comprise additional passive elements such as beam shapers, decanters and tilted optical elements. The method comprises performing temporal multiplexing of phase, amplitude or polarization profiles obtained using the apparatus. Note that herein, the words “mask”, “filter” and “SLM” are used interchangeably to refer to the SLM, the mathematical representation of which are the phase, amplitude or polarization profiles. Herein the term “wavefront profile” is sometimes used as a generic term referring to at least one phase, amplitude or polarization profile.

The SLM can be one of the following:
An annular SLM having a small number of rings.
A single pixel SLM working in a similar manner to a tunable lens. A single pixel SLM is comprised of a single liquid crystal cell. The phase modulation is achieved by changing the voltage profile, which results in the phase profile, for example by having spatial distribution of the resistance or the capacitance of the electrode.
Standard off the shelf, SLM composed of 2D array of rectangular pixels.

The invention can be used with many imaging systems such as optical microscopes, digital camera, cell phone camera, human eye, laparoscopy and more.

The basic idea of the method of the invention is to time-multiplex several phase, amplitude, or polarization profiles generated with a SLM in which each phase profile by itself has some improvement of the image EDOF range in one particular focal region. Multiplexing all the profiles together produces tunable EDOF. The multiplexing can be done off line through a database generation if the SLM is not fast enough or on line when fast enough SLMs are used.

The design approach in this invention is different from that in [11]. While in [11] temporal multiplexing is used in a pseudo-random fashion, in the present invention it is used to create a required superposition between different wavefront profiles. The profiles and their weights are changed according to the required response.

Annular SLM with Small Number of Rings:

In one embodiment of the invention the tunable spatial filter is a transmitting nematic Liquid Crystal (LC) device controlled by voltage. It is important to emphasize that the proposed invention is not limited to LC technology and may be implemented with SLMs comprising an electro-optic or magneto-optic material and with other phase modulation techniques such as micro mirror arrays. In addition in this embodiment the phase filter and the phase profiles have circular symmetry; however in other embodiments of the invention the method and the apparatus may work in other geometries such as a rectangular array of pixels in transmission or in reflection modes.

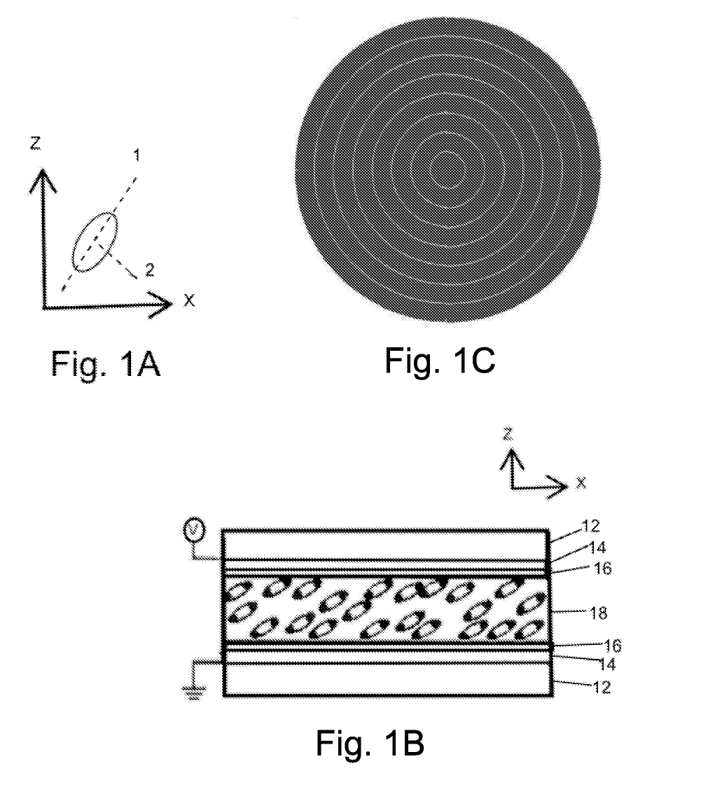

One embodiment utilizes a typical uniaxial birefringent nematic LC material having planar geometry characterized by two refractive indices (FIG. 1A), one nₑ (extra-ordinary) along the long molecule axis 1 and the other nₒ (ordinary) in the perpendicular direction 2 to the molecular axis [12]. A wavefront passing through a LC cell is subject to an effective index of refraction (n_{eff}) which depends on the angle between the direction of propagation and the orientation of the molecules of the LC material and light polarization [12]. To control the phase, the system includes a polarizer located before the LC device and oriented so that the incident polarization excites only one mode with an effective index that varies with the applied voltage. For the case of nematic LC in the homogeneous alignment geometry this direction is along the projection of the molecules long axis on the substrate plane when the light is incident normal to the substrates plane.

FIG. 1B shows a simplified cross-section of a LC cell. The cell 10 is built in a typical layered structure. From top to bottom the layers are: glass 12, indium tin oxide (ITO) 14, alignment layer 16, LC material 18, alignment layer 16, ITO 14 and glass 12. The layers are transparent. The ITO layers are conductive so applying the voltage drop between them imposes an electrical field on the LC material. In response to the potential the molecules of the LC material create a curved profile of a changing tilt angle relative to the z direction. Hence following the above, by changing the applied voltage the n_{eff} for the light passing through the cell is changed. To prevent ion accumulation on the boundaries the applied voltage is bipolar and symmetric, typically at frequency of 1000 Hz and above. The alignment layers are treated to define the LC materials planar alignment and initial small tilt relative to the substrate plane.

It is noted that the invention is not limited to the use of nematic LCs in the particular geometry shown in FIG. 1B. It can be carried out using other LC modes, for example homeotropic aligned LC cells with negative dielectric anisotropy, in-plane switching mode, hybrid mode, ferroelectric LCs, blue phases, and chiral LCs. Configurations to avoid the polarization independence of the phase shift are also possible such as the use of two SLMs in tandem with their optic axis oriented at 90 degrees to each other.

FIG. 1C shows the SLM used in the description herein to demonstrate the invention. In this embodiment the tunable filter 20 is composed of 8 annular rings. All rings are 0.5 mm wide. The overall diameter of the filter is 8 mm. Each ring works as a separate LC cell. By changing the voltage drop on each cell the n_{eff} of the ring is changed. This results in a change of the phase of the light passing through the ring. Assuming normal incidence of incoming light to the cell, the change in the wavefront phase in a first order approximation is [13]:

Φ(i)=(2π/λ)∫[n_{eff}V(i),z)]dz (1)

Where (i) is the ring number, z is the depth coordinate normal to the cell substrates, λ is the wavelength in vacuum, V(i) is the voltage drop on the (i)th ring. By applying different voltage levels on each cell a tunable annular phase profile is created. Since n_{eff} changes by an amount equal to the birefringence which is typically in the range of nₑ−nₒ=0.2 to 0.3 [12], it requires an ˜5λ LC layer thickness in order to create a phase delay of 2π, i.e. ˜3-5 microns for the visible light. The LC cell response and decay time depend mainly on the physical properties of the LC material, the cell thickness and the anchoring conditions at the boundaries [14]. For homogeneous alignment the decay time depends on the thickness of the LC layer hence affecting the possible rate of multiplexing. For a ˜5 micron LC layer the decay time is typically a few tens of msec. However using special driving schemes such as overshooting and undershooting it is possible to improve the speed of nematic LC devices. The use of other fast LC modes, such as the pi-cell and the chiral and ferroelectric LC modes, also circumvents this problem [15].

The present invention is not limited to using optical systems containing an annular SLM to produce the needed phase profiles. The profiles needed for the method of the invention may be obtained using other geometries and with other techniques such as the use of a deformable mirror or an array of micro mirrors or other LC technologies or using other LC structures such as in-plane switching mode, hybrid alignment mode, vertically aligned, twisted nematic mode, ferroelectric in the splayed mode and more. The amplitude mode can also be used by exciting both e and o modes, thus accumulating phase retardation as the beam exits the LC device. This phase retardation is then converted into amplitude modulation using a second polarizer. Without the output polarizer, the beam will experience polarization modulation with no amplitude modulation. Alternatively the amplitude modulation may be obtained also using a diffracting or scattering LC device. The amplitude or polarization modulations can be amplitude-only, polarization-only, combined together or accompanied also with phase modulation.

### The Temporal Multiplexing Method:

It is well known that the coherent Point Spread Function (PSF) of space invariant imaging system is proportional to the Fourier transform of the pupil function. Therefore, by changing the pupil function, the system's response is changed. In incoherent illumination the PSF is proportional to the square of the absolute of the coherent PSF. Thus, by changing the pupil function during the integration time, a nonlinear influence on the system's PSF is achieved. If one knows how to control the amount of Depth of Field (DOF) extension with a passive annular phase mask, a straightforward way to implement tunable Extended Depth of Field (EDOF) will be to change the phase profile presented on the tunable filter.

However, in trying to do so, a few intrinsic problems must be overcome:
First, the first efforts in the literature on this subject were towards creating a maximal EDOF, but middle range EDOF, which is useful to distinguish a controlled group of objects from the background for identification processes such as an image of a human in a photograph or classification in machine vision, generally was not investigated.
Second, in a compact embodiment, the SLM device comprises a limited number of rings and is not necessarily optimal for implementing the previously suggested [1-3],[5] phase profiles.
Third, assuming one knows how to design a phase mask for EDOF, it is still required that changing the phase parameter will allow control of the amount of EDOF in a continuous fashion.

To solve the first and the second problems the inventors of the present invention suggest building a “database” of phase masks from which variable continuous EDOF is composed by temporal multiplexing. The “database” of the phase profiles is tailored to the structure of the tunable spatial filter. In the embodiment described in FIG. 1C the tunable spatial filter is composed of 8 equally spaced rings. However, in the generalized aspect of the invention, the filter and therefore the “database” of phase profiles are not limited to a specific profile or filter size and may include different number of LC cells.

The influence of each phase profile on the final result is determined by the portion of the integration time it is persistent on the tunable spatial filter. The duration of persistence of each phase profile should be significantly longer than the decay time of the SLM cells.

The demand imposed by the third problem is that a combination between existing EDOF masks does not necessarily allow a gradual continuous increase of the EDOF. It may happen that attempts to reduce the EDOF from its maximal value will result in a lack of continuity of the EDOF, i.e. variation in the amount of blur within the DOF range. A lack of continuity in EDOF may be solved by balancing between the appearances of a few phase masks.

The temporal multiplexing in this invention is not limited only to tunable EDOF and may be implemented in other wave front coding. Temporal multiplexing may allow realizing other required target PSF profiles. In addition, in incoherent illumination the PSF is connected nonlinearly to the phase profile, hence temporal multiplexing may allow PSF profiles which cannot be realized with a single phase profile using a reasonable SLM resolution.

Another broad aspect of the present invention is amplitude modulation. The skills and methods in this invention include variation in amplitude and temporal multiplexing to the amplitude and phase profiles. Amplitude modulation using the LC device described above in FIG. 1C can be achieved by rotating the polarizer axis at 45 degrees with respect to the projection of the molecule's long axis on the substrate plane and adding an analyzer at the output preferably at crossed or parallel orientation.

By using the filter's tunability, the temporal multiplexing compensates for the fact that a small number of pixels are used, thus gaining a tunable Optical Transfer Function (OTF) response. The method is explained by starting with the system's response. The coherent point spread function (PSF) of a space invariant imaging system is proportional to the Fourier transform of the pupil function, which is controlled by the SLM, such that:

h∝FT₂{P(x,y)e^{jΘ(x,y)}} (2)

In equation (2), FT₂ is the two dimensional Fourier transform, P(x,y) is the system aperture, θ(x,y) is the phase in the aperture plane. In incoherent illumination the PSF is proportional to the square of the absolute of the coherent PSF [16]:

PSF∝|h|² (3)

The OTF is related to the PSF by an additional Fourier transform. Thus the relation between the pupil phase and the OTF is nonlinear [16]:

OTF∝FT₂{|h|²} (4)

The relation between phase profiles and the OTF is [16]:

$$OTF ∝ {FT}_{2} \{ {\vert {FT}_{2} \{ P ( x , y ) {e}^{jΘ ( x , y )} \} \vert}^{2} \} \qquad ( 5 )$$

In the prior art this relation was used for creating tunable EDOF using high resolution SLM. Being flexible with realizing phase profile the OTF was controlled by means of detailed high resolution cubic phase profile.

However the device described in FIG. 1C has limited resolution, thus flexibility in OTF engineering should come from other concept, which is why the present invention employs temporal multiplexing.

Since FT₂ is a linear operation, by summing responses of independent optical systems the OTF can be engineered.

Assuming N equal energy systems observing a 2D scene, the overall PSF_{T} and OTF_{T} responses are:

$${PSF}_{T} ( ζ , η ; {Φ}_{DF} ) ∝ {\sum }_{n = 1}^{N} {\vert {FT}_{2} \{ P ( x , y ) {e}^{j ( {Φ}_{n} ( x , y ) + {Φ}_{DF} ( x , y ) )} \} \vert}^{2} \\ {OTF}_{T} ( f ; {Φ}_{DF} ) ∝ {\sum }_{n = 1}^{N} {FT}_{2} \{ {\vert {FT}_{2} \{ P ( x , y ) {e}^{j ( {Φ}_{n} ( x , y ) + {Φ}_{DF} ( x , y ) )} \} \vert}^{2} \} \qquad ( 6 )$$

Here φ₄ is the n^{th} pupil phase mask profile, φ_{DF} is the phase error due to defocus, f=(fₓ,f_{y}) is the spatial frequency, and (ζ,η) is the spatial coordinate in the object plane. In equation 6, T stands for total, PSF_{T} and OTF_{T} are a sum of many PSFs or many OTFs respectively.

Similar to this multichannel scheme, a “database” of phase masks φₙ, each with different EDOF response, is built from which the tunable EDOF is composed. The “Database” member will be weighted and summed by a temporal multiplexing. The influence and therefore the weight of each phase profile on the final result is determined by the portion of the overall integration time (Tᵢ), each phase profile is persistent on the tunable spatial filter. The resulting combination between the “Database” components is chosen to yield both the required EDOF and to minimize fluctuations within this Depth of Field (DOF) if there are any. According to this notion, modifying Eq. 6 and omitting the proportionality sign, the overall OTF of the proposed temporal multiplexed system is obtained:

$$OTF ( {f}_{x} , {f}_{y} ; {DF}_{j} ) = \frac{1}{T} {\sum }_{n} {T}_{n} \cdot OTF ( {f}_{x} , {f}_{y} ; {DF}_{j} , {Φ}_{n} ( x , y ) ) \qquad ( 7 )$$

In equation (7), DFⱼ is the amount of defocus in the system, T is the overall integration time, and the response time of the LC device is assumed to be short enough so that the effect of the transient response of the SLM can be neglected Since a typical decay time for a LC that gives 2π phase shift can be in the msec range with a suitable driver or using long enough integration time, this is a reasonable assumption. In addition using fast phase-only LC devices such as ferroelectric LCs it will be possible to easily perform multiplexing on line.

As mentioned above, there are two ways to realize temporal multiplexing: by changing the phase profile during the integration time or by performing weighted average between successive frames each taken with a different SLM phase profile. The first way requires synchronization between the SLM and the camera. The second way is more flexible and was implemented in demonstrating the present invention as described herein below. An advantage of the second method is that it allows recalculation off line, if the images taken with the “Database” were stored. It also relaxes the requirement that the switching speed of the LC SLM be fast enough.

The equivalence between the two methods is achieved by choosing a weight Wᵢ=Tᵢ/T, so that:

$${\sum }_{i} {W}_{i} \cdot OTF ( {f}_{x} , {f}_{y} ; {DF}_{j} ) = \frac{1}{T} {\sum }_{i} {T}_{i} \cdot OTF ( {f}_{x} , {f}_{y} ; {DF}_{j} ) \qquad ( 8 )$$

Following this, a “Database” of phase masks is required. Thus to exemplify the concept the following “database” of 3 phase masks was constructed:

$${Φ}_{OFF} ( {r}_{i} ) = 0 \\ {Φ}_{QPM} ( {r}_{i} ) = {ar}_{i}^{4} + {br}_{i}^{2} \\ {Φ}_{Binary} ( {r}_{i} ) = \{ \begin{matrix}π & if i = 6 , 8 \\ 0 & else\end{matrix} \qquad ( 9 )$$

Where rᵢ designates the radius of the i-th ring of the annular filter, {i=1, 2 . . . 8}. The first component of the “database” is the clear aperture i.e. the filter is “off”. It provides the minimal depth of field and is designated “OFF”. The second mask was of the form of a Quartic Phase Mask (QPM), which is parametric, with parameters (a) and (b), which can be calculated by minimizing a cost function to emphasize spectrum range, i.e. can be designed to prefer a specific pattern within a specific EDOF. Thus the QPM mask can be used to realize a few sub-components for the “database”. For the purpose of demonstrating the method of the invention the values a=0.8, b=0.2 were used in the simulation and experiment discussed herein below. Finally a binary mask was constructed in which all rings are 0 but rings 6 and 8 are set to π, this mask is designated “Binary”. The choice of the masks was made according to the results of simulations of a similar aberration free system observing a 16 mm height “staircase” object. Under these conditions the choice of the masks “OFF”, “QPM” and “Binary” yields short, medium and long EDOF respectively. It should be mentioned that the choice of masks given in equation 9 is only one case and there are many other masks known to extend the DOF which can be used as combined with each other according to the methodology of the invention to extend the DOF more than a single mask can do.

### Integration in Imaging Systems:

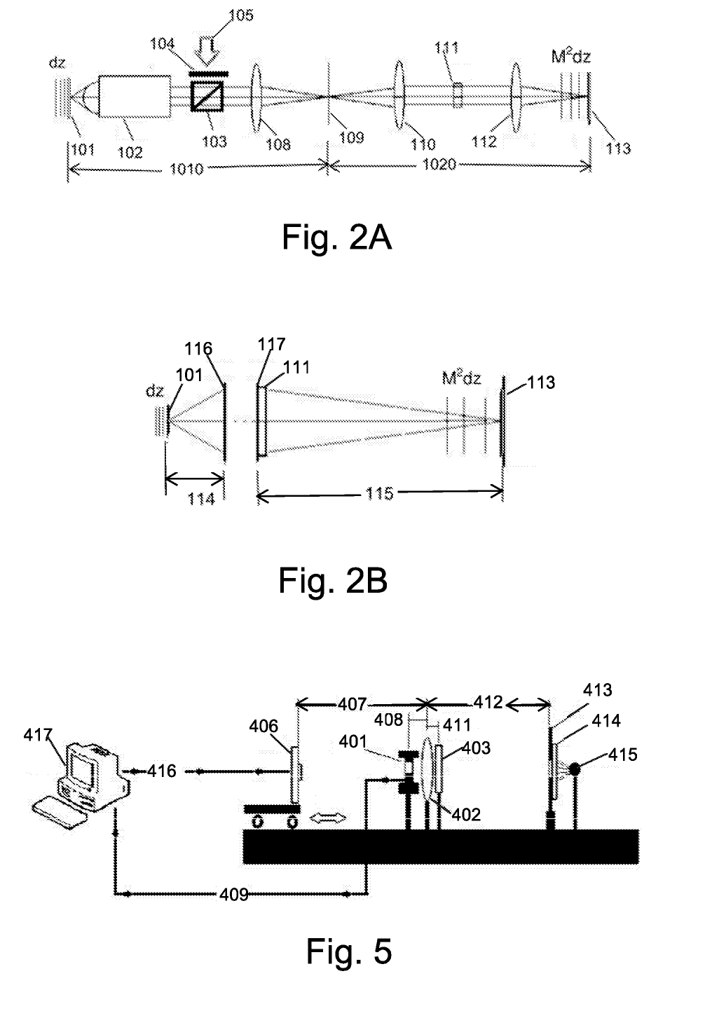

Generally the filter should be placed in the system's aperture stop or in its conjugate plane. Such a system is described in FIG. 2B. The system's terminals are the entrance pupil 116 and exit pupil 117, which are the images of the system's aperture stop. The wave front propagation from the object 101 is considered relative to the entrance pupil 116 of the system. The propagation to the image plane 113 is considered relative to the exit pupil 117 of the system. The filter 111 should be placed in one of the conjugate planes of the aperture stop. The filter can be imaged on one of these terminals. The imaging system can be monospectral, multispectral, or hyperspectral.

A first embodiment of the temporal multiplexed tunable EDOF is in a photographic system. A schematic description of the system is presented in FIG. 2B. The method of the invention can in principle be embedded in more complex systems by placing the SLM in a “4F” system [17] or in the image plane of the aperture stop. An example for such a system may be a light microscope. A schematic implementation of such a system is presented in FIG. 2A. The microscope system is divided into a “microscope” 1010 and a “4F system” 1020. Another important example is in imaging systems in which more than one camera are used to extend the depth of field such as in laparoscopy. In the case of multi-camera system each imaging channel may have its exit pupil plane in which the SLM mask can be inserted to give higher EDOF of that particular channel.

Referring to FIG. 2A, the object 101 is illuminated through the objective 102. The illumination source 105 is coupled to the objective 102 through a beam splitter 103. Illumination passes through a linear polarizer 104 to insure the light is polarized, as required for the tunable LC spatial filter. The light which strikes the object 101 is reflected back to the objective lens 102, which collects the light and collimates it to the tube lens 108. The tube lens creates a magnified image 109 of the object 101 in the entrance of the “4F system” 1020. The 4F system is composed of two positive lenses 110 and 112. The magnified image 109 of the microscope 1010 is placed in the front focal plane of the first lens 110 so that the Fourier transform of the image is received in the back focal plane. This plane is conjugate to the microscope pupil plane, hence it is the proper plane at which to locate the tunable filter 111. The filter plane 111 is the front focal plane of the second lens 112. Propagation through lens 112 results in an additional Fourier transform at its back focal plane. Finally, a filtered image 113 of the object 101 is obtained in the back focal plane of the second lens 112. The imager is placed in that plane. In another embodiment the filter may be placed in an image plane of the aperture stop.

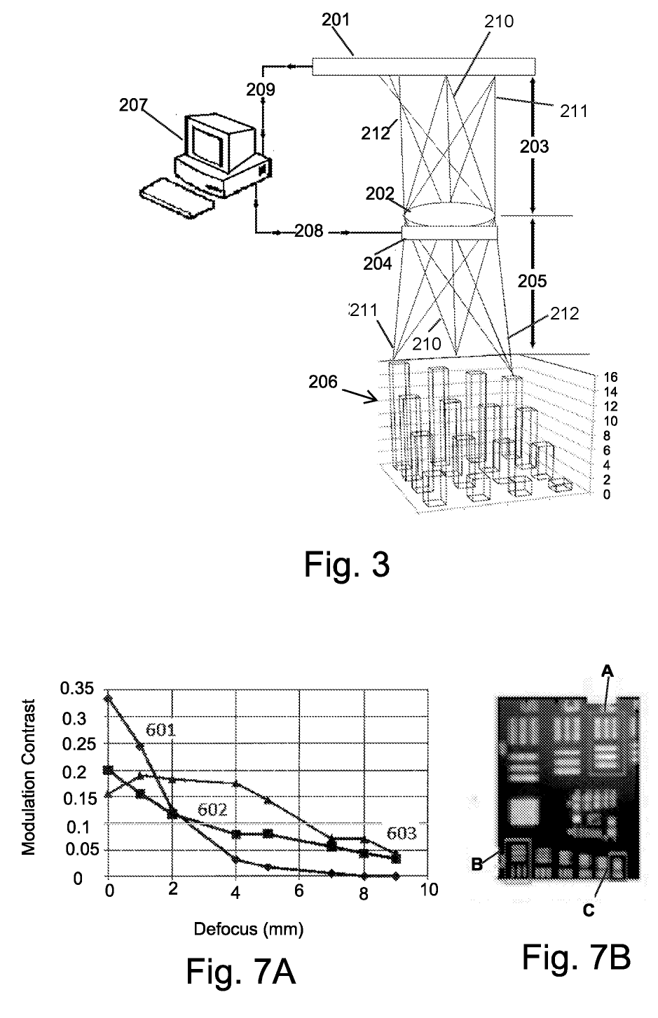

FIG. 3 is a schematic presentation of a simulated system used in a simulation carried out to demonstrate the invention. The system in FIG. 3 is based on the general photographic system shown in FIG. 2B. The imaging system in this simulation is modeled as a thin lens 202 attached to an active annular filter 204, which is the SLM shown in FIG. 1. The imager 201 is located in the “image space” at a constant distance 203 from the imaging lens 202. The image is transferred to a process and control unit 207 via camera cable 209, which also controls the SLM via control cable 208. In the simulation the filter 204 is implemented in an image plane of the exit pupil of imaging lens 202. In an optional embodiment, the filter may be placed not in the exit pupil as long as it sufficiently modulates the wave front. The object 206 is a “staircase” structure comprised of sixteen steps located in the “object space”. In this simulation the step height is 1 mm. The steps are arranged in four rows and four columns and, as can be seen in the figure, descend uniformly in height from a maximum height of 16 mm for the step on the left end of the back row to a height of 1 mm for the step on the right side of the front row. The object distance 205 is measured from the top of the highest stair. The system is assumed to be corrected for aberrations, except for defocus. The ray tracings 210, 211, and 212 respectively show the focus of an image of a point at the object distance 203, i.e. perfect focus, and the top faces of the steps at the left and right ends of the back row of steps. Ray tracing 212 shows the amount of defocus for the step having height 13 mm.

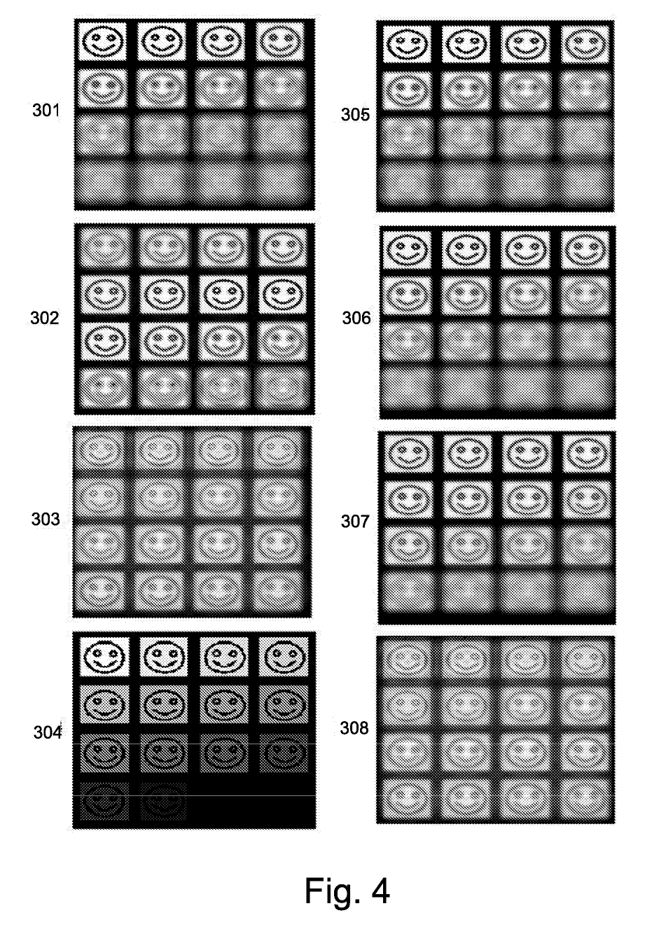

In the simulation, some of the results of which are shown in FIG. 4, the object distance 205 is 265 mm and the image distance 203 is 216 mm. The lens focal length is 120 mm. The system's aperture is 8 mm and the active annular filter 204 is a LC SLM with 8 equally spaced tunable filter rings. Quasi monochromatic incoherent illumination is assumed, with λ=0.633 μm. The device response time is ignored by assuming a much longer integration time.

FIG. 4 presents, the simulation results for “Smiley” icons placed on the top of each of the 16 stairs. The image when the filter is “off” (mask Φ_{OFF}) is shown in 301, the image when using the QPM profile (mask Φ_{Binary}) is presented in 302, and the image with the binary profile (mask Φ_{Binary}) is presented in 303. The object topography for the object 206 shown in FIG. 3 is shown in 304. In this image the higher the step the brighter the smiley face on it appears. The column of images on the right side of FIG. 4 shows the simulation results for object 206 using four different temporal multiplexing combinations. The imaging results are presented with 4 different temporal multiplexing rates. In each multiplexing the exposure time is divided between the different phase profiles.

For brevity the exposure time in each phase profile, i.e. the weight of each mask/profile, is indicated in the following as the percentage of the integration time, designated with [%] before the mask designation. The phase profiles are members of the “Database” as given in equation 9. The temporal multiplexing combinations shown in FIG. 4 are: 305—minimum EDOF the tunable spatial filter is a 100% clear aperture (OFF) result, and then the tunable system is turned off. The DOF is limited to the 6th layer. 306—minimum-medium EDOF—multiplexing 75% OFF with 25% QPM extends the reasonable resolution down to the 9th stair. 307—medium EDOF—a combination of 50% OFF and 50% QPM extends the DOF to the 12th stair. 308—maximum EDOF—is achieved by using 100% binary. It is seen that by using different temporal multiplexing, different continuous EDOF ranges are achieved.

### Experimental Demonstration:

In order to demonstrate the concept an 8 ring LC SLM was built and tested in a simple imaging system similar to that in the simulated system presented above.

FIG. 5 schematically shows the experimental arrangement. Light from a red light emitting diode (LED) 415 passes through a diffuser 414 and passes through a USAF1951 target, which is used as an object 413. The imaging system, which is composed of linear polarizer 403, double convex lens 402, and SLM 401, images the object 413 on camera 406. SLM 401 is the eight ring annular filter shown in FIG. 1C. The image is transferred from camera 406 through camera cable 416 where it is captured by the process and control unit 417 which also controls the SLM 401 via control cable 409. Camera 406 is symbolically shown supported by a mechanism that enables it to be moved linearly back in forth in the direction shown by double-headed arrow 410. This allows the object distance 407, i.e. the focus to be adjusted to obtain different defocus levels. Also shown in the figure are image distance 412, the distance 411 between polarizer 403 and lens 402, and the distance 408 between lens 402 and SLM 401.

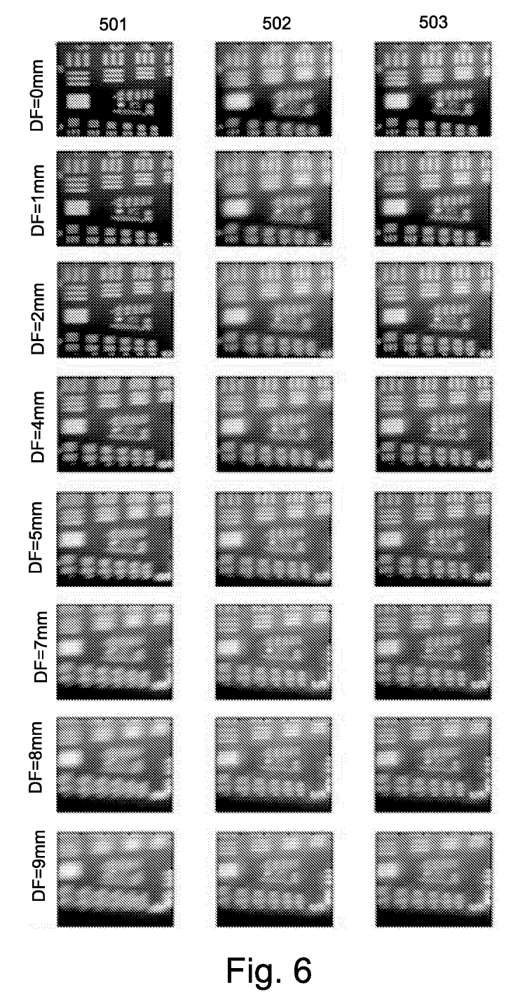

FIG. 6 shows the “database”, i.e. the collection of images taken with each of the masks, used in carrying out the experiment. From left to right the columns are: column 501—filter “OFF”; column 502—filter on with “Binary” phase mask; column 503—filter on with “QPM” phase mask. In FIG. 6 the rows represent different defocus (DF) levels where the amount of DF in mm is shown to the left of each row.

The average target contrast vs. defocus in mm is shown in FIG. 7A. The contrast was measured from 3 different spatial targets with three different spatial frequencies. FIG. 7B shows the three areas A,B,C on USAF1951 target 413 at which the contrast was measured. The contrast level is presented in the Y axis while the X axis is the amount of defocus in mm. Each graph stands for a different spatial filter: the “OFF” filter curve is designated 601 (diamond symbols); the “Binary” filter curve is designated 602 (squares); and the “QPM” filter curve is designated 603 (triangles).

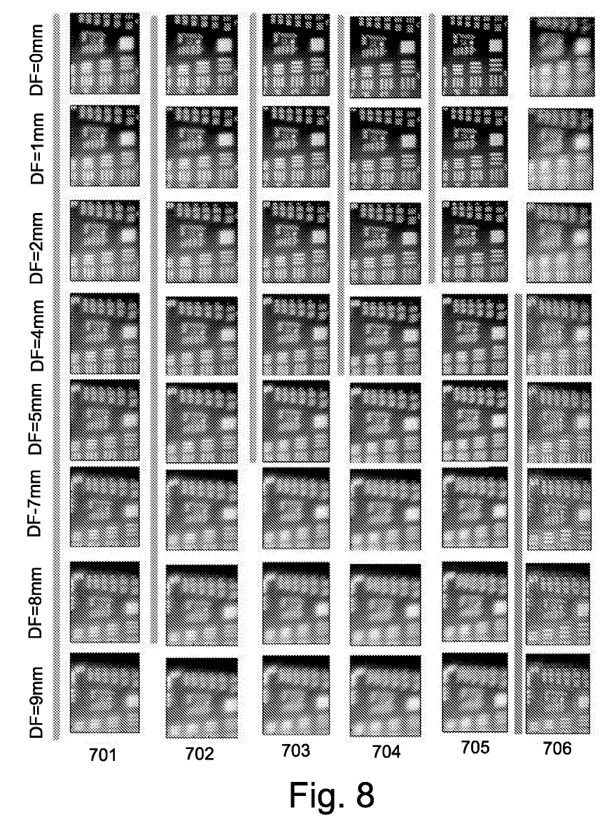

FIG. 8 presents the tunable EDOF experimental results found after temporal multiplexing on the “Database” components of FIG. 6. Each of the columns 701-706 shows different EDOF level corresponding to a different weight vector

[0 0.4 0.6], [0.25 0.35 0.4], [0.5 0.25 0.25], [0.7 0.3 0], [1 0 0], [−0.32 1 0] respectively, wherein the weights are given as a fraction of the total. Columns 701 to 705 represent EDOF range in a decreasing order. The range of the EDOF is illustrated by the length of the gray line to the left of each column.

Normally the contrast of a 3D object decreases as the defocus increases (see, for example, column 705). In column 706 the opposite result is obtained where the distant surfaces are clearer than the close ones. This was achieved by imposing a condition of zero contrast on the closer surfaces while maintaining a minimum of 5% contrast on the further surfaces as a condition for an optimization scheme [18].

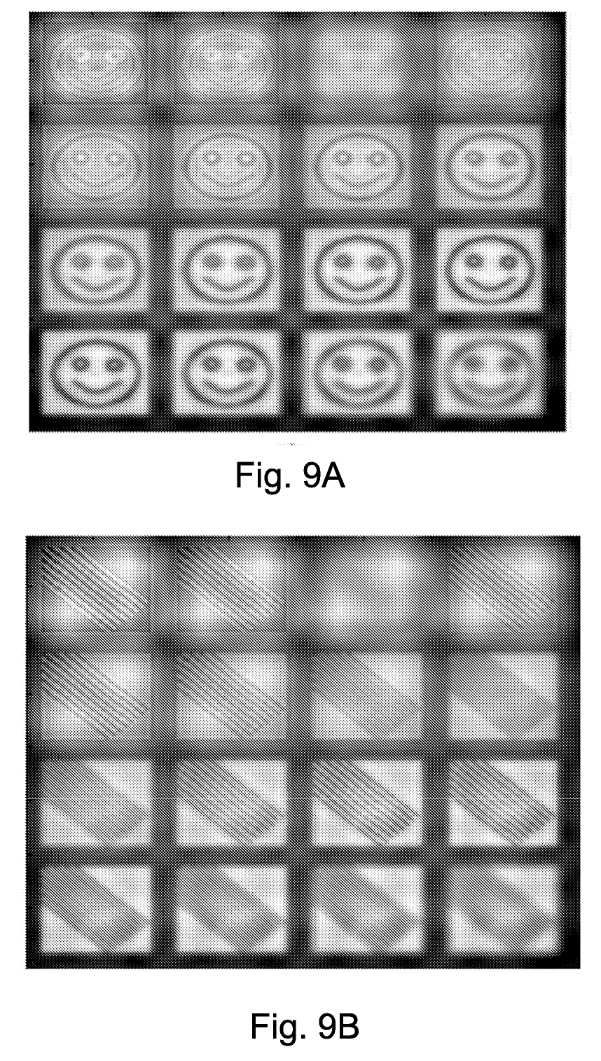

The simulated and experimental systems are similar; thus, although the weight vector was not optimized for the simulated system, it was used to perform inversion of EDOF order also on the simulated data. FIGS. 9A and 9B show respectively the result of inverting the EDOF order using the same weight vector in simulated and actual experiments.

It is noted that the above simulation and experimental results are presented to illustrate the invention, which is not limited to the specific details described. For example, the database can include many other phase profiles and is not limited to the three mentioned above. Another embodiment of the system may include an additional image restoration phase. Based on the knowledge of the phase mask, the systems' resolution may be improved by post processing or performing image restoration.

In yet another embodiment of the method, the time multiplexing can be done off line as in the experimental work presented above. This embodiment is important when the switching time of the SLM is comparable or longer than the integration time of the camera. First the “database” of images corresponding to the different phase profiles is generated and then multiplexed together. This option relaxes the requirement on the LC device speed.

In many applications such as adaptive optics and others, SLMs can be used for compensating of optical aberrations [19]. Previous art showed that SLM lens attached to the system main lens can be used for focal distance correction [20]. The circular symmetry of the proposed filter can be used for realizing such a tunable lens phase [21]. The need for focus correction can originate from the main lens chromatic aberration and can be corrected by the SLM lens [22]. The Liquid Crystal SLM usually suffers from dispersion. Thus, under the same given voltage profile the resulting phase profile depends upon the wavelength. This problem can be avoided by optimizing over the bandwidth in a similar manner to what is being done for passive dielectric filters [23]. Alternatively one can change sequentially red (R), green (G) and blue (B) (RGB), in a manner similar to how some of the RGB display systems work [24], and in each sequence the camera output is saved only at the corrected wavelength. The R, G, B can correspond to sequential illumination of the object by RGB light or simply by using color camera with the RGB pixels grabbed sequentially. The phase profile for a specific wavelength may include simultaneously both focus correction and EDOF. The temporal phase mask will be of the form:

$$Φ ( {r}_{i} , λ , t , n ) = {Φ}_{EDOF} ( {r}_{i} , λ , t , n ) - j \frac{2 π}{λ} \cdot \frac{{r}_{i}^{2}}{f ( λ , t )} \qquad ( 10 )$$

Wherein, rᵢ is the ring number, λ is the wavelength number, t is the time, f is the focal plane, and the type of EDOF mask in use is represented by n.

Although embodiments of the invention have been described by way of illustration, it will be understood that the invention may be carried out with many variations, modifications, and adaptations, without exceeding the scope of the claims.

### BIBLIOGRAPHY

[1] E. Ben-Eliezer, E. Marom, N. Konforti, Z. Zalevsky, “Radial Mask for Imaging Systems That Exhibit High Resolution and Extended Depths of Field”, App. Opt., 45, 2001-2013 (2006).
[2] S. Mezouari and A. R. Harvey, “Phase Pupil Functions for Reduction of Defocus and Spherical Aberrations”, Opt. Lett., 28, 771-773 (2003).
[3] X. Mo, “Optimized Annular Phase Masks to Extend Depth of Field”, Opt. Lett., 37, 1808-1811 (2012).
[4] Z. Zalevsky, S. Ben-Yaish, “All Optical System and Method for Providing Extended Depth of Field of Focus of Imaging”, US2009 \0116096 A1.
[5] E. Marom, E. Ben-Eliezer, N. Konforti, B. Milgrom, “Optical Imaging System with Extended Depth of Field and Method for Designing an Optical Imaging System”, US20100097487.
[6] E. R. Dowski, T. Chathey, “Extended Depth of Field Through Wave-Front Coding”, App. Opt. V34, No 11, 1859-1866 (1995).
[7] W. T. Cathey and E. R. Dawski, “Extended Depth of Field Optical Systems”, U.S. Pat. No. 7,218,448 B1.
[8] W. Chi, N. George, “Electronic Imaging Using a Logarithmic Aspheric”, Opt. Lett. 26, 875-877 (2001).
[9] D. Hong, K. Park, H. Cho, M. Kim, “Flexible Depth-Of-Field Imaging System Using A Spatial Light Modulator”, Appl. Opt., V46, N36, 8591-8599 (2007).
[10] H. S. El-Ghoroury, A. Majumder, R. G. Brown, A. J. Lanzone, “Hierarchical Multicolor Primaries Temporal Multiplexing System”, U.S. Pat. No. 8,098,265 B2.
[11] R. Raskar, “Coded Exposure Photography: Motion Deblurring Using Fluttered Shutter”, ACM, SIGGRAPH, 795-804, (2006)
[12] D-K. Yang, S-T. Wu, “Fundamentals of Liquid Crystal Devices,” (Wiley 2006), Chap. 6 and 7.
[13] S. Saeed, P. J. Bos, and Z. Li, “A Method of Generating Full Color in a Liquid Crystal Display Using Birefringent Filters”, Jpn. J. Appl. Phys. 40, 3266-3271 (2001).
[14] H. Wang, T. X. Wu, X. Zhu, S.-T. Wu, “Correlations between liquid crystal director reorientation and optical response time of a homeotropic cell”, J. of Appl. Physics, 95, 5502-5508 (2004).
[15] I. Abdulhalim, “Continuous phase only amplitude light modulation using ferroelectric liquid crystals with fixed boundary orientations”, Optic. Commun., 108, 219-224 (1994).
[16] J. W. Goodman“, Introduction to Fourier Optics, 2nd” (McGraw-Hill 1996).
[17] P. K\check{r}í\check{e}k, G. M. Hagen, “Spatial light modulators in fluorescence microscopy”, Mic. Sc., Tech., App. and Ed., 1366-1377 (2010).
[18] I. Klapp, A. Solodar, and I. Abdulhalim, “Low cost annular SLM for tunable extending depth of field”, App. Opt. Accepted 29 May (2014).
[19] D. V. Wick and B. E. Bagwell, “Advances in Adaptive Imaging,” SPIE, newsroom, 10.1117/2.1201109.003813 (2011).
[20] V. Mico, J. Garcia, L. Camacho and Z. Zalevsky, “Quantative phase imaging in microscopy using a spatial light modulator”, Chapter 6 in Coherent light microscopy, Eds, P. Ferraro, A. Wax, Z. Zalevsky, Springer (2011).
[21] A. Solodar, I. Klapp, and I. Abdulhalim“, Annular Liquid Crystal Spatial Light Modulator for Beam Shaping and Extended Depth of Focus” Opt. Commun., 23, 167-173 (2014).
[22] A. Márquez, C. Iemmi, J. Campos, J. Escalera, and M. Yzuel, “Programmable apodizer to compensate chromatic aberration effects using a liquid crystal spatial light modulator”, Opt. Express 13, 716-730 (2005).
[23] B. Milgrom, N. Konforti, M. A. Golub, and E. Marom, “Pupil coding masks for imaging polychromatic scenes with high resolution and extended depth of field,” Opt. Express, 18, 15569-15580, (2010).
[24] F. Yaras H. Kang, and L. Onural, “Real-time multiple SLM color holographic display using multiple GPU acceleration”, A, Digital Holography and Three-Dimensional Imaging, Optical Society of America, DWA4 (2009).

1. A method for providing Tunable Extended Depth Of Field (TEDOF) to an optical system, the method comprising:
a) providing at least one tunable Spatial Light Modulator (SLM) in the pupil plane or in the conjugate plane of the pupil plane of the optical system;
b) building a database of masks tailored to the structure of the tunable SLMs;
c) using the optical system to grab at least two images using different masks from the database of masks; and
d) time multiplexing the wavefront profiles of the at least two images to produce a final image;
wherein each of the profiles gives a Depth of Field (DOF) lower than the DOF of the final image.

2. The method of claim 1 wherein the multiplexing is done off line on a generated database of images corresponding to the different wavefront profiles generated at the pupil plane of the imaging system or its conjugate either in transmission or in reflection modes.

3. The method of claim 1 wherein the multiplexing is done on line in real time.

4. The method of claim 1 wherein each wavefront profile provides EDOF of the imaging system.

5. The method of claim 1 wherein the SLMs spatially modulate at least one of the phase, the amplitude, or the polarization or any combination of these parameters of the wavefront.

6. The method of claim 1 wherein the SLMs comprise liquid crystals, an electro-optic or magneto-optic material or a mechanical deformable micro mirror array.

7. The method of claim 1 wherein the method is used for image restoration.

8. The method of claim 1 wherein the SLMs have circular symmetry.

9. The method of claim 8 wherein the SLMs are comprised of annular sections, each of which is controlled separately.

10. The method of claim 9 wherein the SLMs are comprised of no more than ten annular sections.

11. The method of claim 1 wherein the central part of the mask is obstructed.

12. The method of claim 9 wherein several annular sections of the mask are obstructed.

13. The method of claim 1 wherein at least one of the SLMs is a single pixel tunable focus lens.

14. The method of claim 1 used with multi-camera systems in which each camera channel has its own tunable EDOF.

15. The method of claim 1 used with a multispectral or a hyperspectral imaging system, the method comprising generating the SLM masks for each particular wavelength separately.

16. The method of claim 1 wherein the SLMs are used for chromatic corrections thereby allowing simultaneous correction of both focus and EDOF.

17. The method of claim 1 used with an optical system comprising a camera having RGB channels, the method comprising synchronizing the camera RGB channels with the SLMs, thereby allowing correction for wavelength dependence by grabbing sequentially the color channels associated with the optimized SLM's mask for each specific color and then, after processing, displaying the final RGB image with improved EDOF.

18. The method of claim 1 in which the SLM masks are integrated into a digital camera system.

19. The method of claim 18 in which the digital camera system is that of a mobile phone and the processing abilities of the phone are used to operate the SLMs and the processing of the grabbed images.

20. The method of claim 1 wherein, after the final image has been produced, it is image processed for contrast and resolution enhancement.
